(19) United States
(12) Patent Application Publication
(10) Pub. No.: US 2013/0056302 A1
(43) Pub. Date: Mar. 7, 2013

(54) FALL PROTECTION SAFETY DEVICE WITH END OF SERVICE LIFE INDICATOR

(71) Applicant: Peter Ronald Bishop, Mississauga (CA)

(72) Inventor: Peter Ronald Bishop, Mississauga (CA)

(73) Assignee: HONEYWELL INTERNATIONAL INC., Morristown, NJ (US)

(21) Appl. No.: 13/224,884

(22) Filed: Sep. 2, 2011

(51) Int. Cl. A62B 35/00; D03C 13/00; B23P 11/00; D05B 1/00

(52) U.S. Cl. 182/3; 112/475.01; 139/35; 29/428

(57) ABSTRACT

Embodiments relate to fall protection safety devices, such as various fall arresting personal safety devices as safety harnesses, belts, and/or lanyards by way of non-exclusive example, having one or more end of service life indicators. Typically, the device would include webbing and one or more end of service life indicators for indicating when the webbing has been exposed to a sufficient concentration of some degrading condition for sufficient duration that there is a risk that the structural integrity, strength, and/or tenacity of the webbing would fall below the safety limit. Such devices would allow for a quick visual inspection to determine if the fall protection device should be retired from service.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### FIELD

Disclosed embodiments relate generally to fall protection safety devices, and more specifically to fail arresting personal safety devices having webbing and one or more end of service life indicators.

### BACKGROUND

When working at heights, it is standard industry practice (often guided by legal requirements of governmental agencies such as OSHA) to employ some sort of fall protection safety device. Typically, the fall protection safety device is a fall arresting personal safety device, which might include by way of nonexclusive example a safety harness, belt, lanyard, anchor slate, or lifeline. For such devices to effectively protect users from dangerous falls, they must be of sufficient strength to bring a fall to a stop and to then hold the user above the ground. Thus, the structural integrity and/or strength of such devices may be critical in preventing serious bodily injury from a fall. Currently, there is no good way to determine if fall protection safety devices that have been used over some period of time still retain their original structural integrity/strength characteristics, or if they have been significantly degraded to the point where they should be retired from service. At best, some industries may simply apply a uniform rule (based mainly on guesswork) that devices should be retired a certain number of years after manufacture. But this is just a rough estimate, and does not take into account the specific use and/or exposures of a particular device. For example, a device might have been stored away in inventory for many years, such that its actual useful lifespan might be many years more than the uniform rule would assume. This could lead to costly waste as useful devices are needlessly discarded. On the other hand, a particular device might be used in an environment where it is exposed to one or more harmful substances that could be detrimental to its structural integrity/strength. This could lead to an ineffective device being used beyond its actual useful lifespan (based on the application of a uniform rule). Applicant feels that a better method of determining when to retire safety devices is thus needed.

### SUMMARY

in one aspect, the disclosure may include a fall arresting personal safety device comprising: webbing of sufficient strength to effectively catch and hold a user falling from a height (for example, webbing able to support about 5000 pounds to about 7000 pounds); and one or more end of service life indicators operable to indicate exposure to one or more degrading conditions; wherein the one or more end of service life indicators change in visual appearance when exposed to sufficient concentration and duration of degrading condition to weaken the strength of the webbing; wherein the webbing comprises one of the following: nylon, polyester, Nomex, Kevlar, and combinations thereof; and wherein the webbing is formed into a safety harness, belt, or lanyard. In embodiments, the one or more end of service life indicators might indicate exposure to one or more of the following degrading conditions: UV, heat, solvent, inorganic chemical, inorganic acid, organic acid, alkali, organic chemical, fertilizer, and/or bleaches. And in embodiments, the change in visual appearance might comprise a change in color, actual physical degradation of the indicator material, and/or some other change in physical appearance. In some embodiments, the webbing might comprise an inner and an outer surface, and wherein the one or more end of service life indicators each comprise sensing material permanently attached to the outer surface of the webbing. In other embodiments, the one or more end of service life indicators might comprise sensing thread sewn into a pattern on the webbing. And in some embodiments, the one or more end of service life indicators might comprise tracer fibers (perhaps of sensing material), and with the tracer fibers woven into the webbing structural support material.

In other aspects, the disclosure might comprise a fall protection safety device comprising: webbing of sufficient strength to effectively catch and hold a user's fall from a height (for example, webbing able to support about 5000 pounds, or alternatively, about 7000 pounds); and one or more end of service life indicators operable to indicate exposure to one or more degrading condition. In some embodiments, the one or more end of service life indicators might indicate exposure to one or more of the following degrading conditions: UV, heat, solvent, inorganic chemical, inorganic acid, organic acid, alkali, organic chemical, fertilizer, and/or bleaches. And in some embodiments, the one or more end of service life indicators might change in visual appearance when exposed to sufficient concentration and duration of degrading condition to (materially) weaken the strength of the webbing (to a point where the safety factor and/or level is compromised for example). Such a change in visual appearance might comprise a change in color in some embodiments. And in some embodiments, the webbing may comprise an inner and an outer surface, with the one or more end of service life indicators each comprising sensing material permanently attached to the outer surface of the webbing. In other embodiments, the one or more end of service life indicators may comprise sensing thread sewn into a pattern on the webbing. And in still other embodiments, the one or more end of service life indicators may comprise tracer fibers, with the tracer fibers woven into the webbing. In embodiments, the webbing may comprise one of the following: nylon, polyester, Nomex, Kevlar, and combinations thereof; and/or the webbing may comprise sufficient layers of material and stitching patterns so that the webbing meets strength requirements. The webbing may be formed into a safety harness, belt, or lanyard in some embodiments.

Yet another aspect might include a method of forming a fall protection safety device comprising: providing webbing of sufficient strength to effectively catch and hold a user's weight (perhaps along with an additional safety factor); providing one or more end of service life indicators; permanently attaching the one or more end of service life indictors to the webbing; and forming the webbing into the fall protection safety device. Some embodiments further include forming the webbing. In some embodiments, the webbing comprises an outside surface, and the one or more end of service life indicators are sewn onto the outside surface of the webbing. The one or more end of service life indicators might comprise sensing thread, with the sensing thread stitched onto the webbing in some embodiments. In other embodiments, the one or more end of service life indicators may comprise tracer fibers, and permanently attaching the one or more end of service life indicators to the webbing may further comprise weaving the tracer fibers into the webbing during formation. Persons of ordinary skill will better understand and more fully appreciate embodiments based on the drawings and detailed description.

### BRIEF DESCRIPTION OF THE DRAWINGS

For a more complete understanding of the present disclosure, and for further details and advantages thereof, reference is now made to the accompanying drawings, in which:

FIG. 1 is an illustrative embodiment of a safety belt with a tether removably attached;

FIGS. 2A and 2B illustrate an embodiment of a safety harness with a tether removably attached;

FIG. 3 illustrates a section of an embodiment of webbing (of the sort that the safety belt, harness, or tether of FIGS. 1, 2A, and/or 2B, for example, might be made of) having an exemplary indicator strip end of service life indicator;

FIG. 4 illustrates a section of an embodiment of webbing having an exemplary pattern of sensing thread stitched thereon as an end of service life indicator;

FIG. 5 illustrates a section of an embodiment of webbing having a sensing sheet attached thereto as an end of service life indicator;

FIG. 6 illustrates a section of an embodiment of webbing having sensing patches attached thereto as end of service life indicators;

FIG. 7 illustrates a section of an embodiment of webbing having three sensing strips; and

FIG. 8 illustrates a section of an embodiment of webbing in which tracer fibers of sensing material are woven throughout the webbing.

### DETAILED DESCRIPTION

The following brief definition of terms shall apply throughout the application:

The term “outer” or “outside” refers to a direction away from a user, while the term “inner” or “inside” refers to a direction towards a user;

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example; and

If the specification states a component or feature “may,” “can,” “could,” “should,” “preferably,” “possibly,” “typically,” “optionally,” “for example,” or “might” (or other such language) be included or have a characteristic, that particular component or feature is not required to be included or to have the characteristic.

Disclosed embodiments may relate to fall protection safety devices having one or more end of service life indicators. Typically, the devices are fall arresting personal safety devices, such as safety harnesses, belts, lanyards, anchor slates, lifelines (which may be retractable), and the like, by way of nonexclusive example. Embodiments of such devices often might comprise webbing of sufficient structural integrity, strength, and/or tenacity to effectively protect against dangerous falls (by, for example, catching and/or holding the user in the event the user should fall from a height), along with one or more end of service life indicators to allow a user to quickly and easily inspect the safety of the device and to determine whether the device is still effective for safety purposes or whether there is sufficient risk of degradation that the device should be retired.

Persons of skill will be familiar with the types of webbing typically used for such devices. By way of example, the webbing typically may comprise nylon, polyester, NOMEX™, KEVLAR™, DYNEEMA™, and/or combinations thereof. In some embodiments, the webbing might typically include only a single type of structural support fiber/material. While other manufacturing methods may be appropriate, in embodiments such webbing may typically be woven. The dimensions (such as width and thickness of the webbing material), number of layers of material and stitching patterns and/or needle-punching used in creating the webbing might typically be selected so that the webbing has sufficient structural integrity/strength/tenacity for safety purposes (for example, to catch and support the weight of a user falling from a height). Oftentimes, the minimum strength requirement for webbing in such devices is legally set (based for example on OSHA requirements) and/or is set by industry standard or custom. So for example, the minimum legal standard might be 5,000 pounds (supportable by the webbing), while in a pa industry the standard or custom might be to have a minimum strength of 7,000 pounds (supportable by the webbing). Regardless, the webbing must possess sufficient strength to provide the safety restraint or fall arresting capabilities for embodiments of the device. In one embodiment, the webbing might be made of TREVIRA™ High Tenacity Spunbond Polyester with a minimum strength rating of 5,000, or alternatively 7,000 pounds.

Depending on the material of the webbing, embodiments of the device may be sensitive to exposure of one or more potentially degrading condition (such that exposure to that degrading condition in sufficient concentration for sufficient time/duration may weaken and/or degrade the structural integrity/strength/tenacity of the webbing). Embodiments of the device therefore typically might include one or more end of service life indicators, whose purpose is to detect such exposure to degrading conditions and to provide a visual indication when such exposure might cause a potential risk to the structural integrity/strength/tenacity of the webbing.

The potential degrading conditions might vary depending on the specifics of the webbing, but the following are examples of possible degrading conditions that embodiments of the device might try to detect/sense/indicate. By way of non-exclusive example, the end of service life indicators might sense/respond to one or more of the following: UV radiation (such as sunlight), heat or elevated temperatures, solvents, inorganic chemicals, acids, alkalis, organic chemicals, fertilizers, bleaches, radiation, fuels, plasticizers, or gases. If the webbing material is sensitive to exposure to one or more such conditions, then the end of service life indicator(s) for embodiments might detect exposure to such condition(s) in sufficient quantity/concentration for sufficient duration to degrade/weaken the webbing, allowing a user to discern the actual end of effective service life for the device more accurately. In embodiments, the one or more end of service life indicators might sense one or more of the following conditions, for example:

Inorganic chemicals, such as ammonium sulphide, potassium carbonate, potassium permanganate, and/or sodium carbonate for example;

Acids, such as hydrofluoric acid, hydrochloric acid, nitric acid, sulphuric acid, and/or chlorosulphonic acid for example;

Alkalis, such as ammoniacal media, caustic potash, and/or caustic soda for example;

Organic chemicals, such as amines (such as chloramine, cyclohexylamine, hexylamine, and/or trimethylamine), benzyl alcohol, and/or tetrachlorethane for example;

Fertilizers, such as those having ammonium salts for example;

Elevated temperatures such as above about 150 degrees Celsius (for over about 20 hours, for example), about 160 degrees C., about 180 degrees C., about 200 degrees C., and/or above about 220 degrees C.; or above about 60 degrees Celsius, about 75 degrees C., and/or about 100 degrees C. in conjunction with exposure to other degrading condition(s) for example;

Bleaches, such as those having hypochlorite of lime solutions for example;

UV and/or sunlight, such as about 250 hours of exposure or about 500 hours of exposure for example; and/or

Solvents such as nitrobenzene, dichlorobenzene, phenl/tetrachloroethane, benzyl alcohol, chlorinated hydrocarbons (such as methylene chloride, tetrachloroethane, or trichloroethylene) for example.

If the webbing is sensitive to more than one degrading condition, then more than one indicator might be used (allowing the user to determine if the device has been exposed to any number of degrading conditions that might compromise safety). Alternatively, a single indicator that is sensitive/responsive to more than one degrading condition could be used.

Nonexclusive examples of indicators might include tracer fibers of materials sensitive to a particular degrading condition, material similar to that used on badges typically worn by personnel in chemical and/or nuclear facilities, or other sensing material (sensitive to one or more degrading condition). The indicator(s) typically provide visual notification or warning when exposure to the degrading condition is sufficient to merit retirement of the device. By way of nonexclusive example, this visual notification could be a change in visual appearance of the indicator, such as a change in color (for example, a color that is initially bright, fading due to exposure) or actual physical degradation of the indicator material itself, by way of nonexclusive example.

The end of service life indicators are typically attached to the webbing in embodiments of the device. In some embodiments, the indicators could be removably attached to the webbing. For example, in some embodiments the indicators might be badges or patches that snap onto the webbing material. In other embodiments, however, the end of service life indicators might be permanently attached to the webbing. Such permanent attachment might, by way of nonexclusive example, include having the indicators sewn onto the surface of the webbing, having indicators attached to the surface of the webbing using adhesive, by stitching reactive fibers into the webbing, or by distributing reactive fibers (such as tracer fibers, for example) throughout the webbing, typically with tracer fibers woven into the webbing.

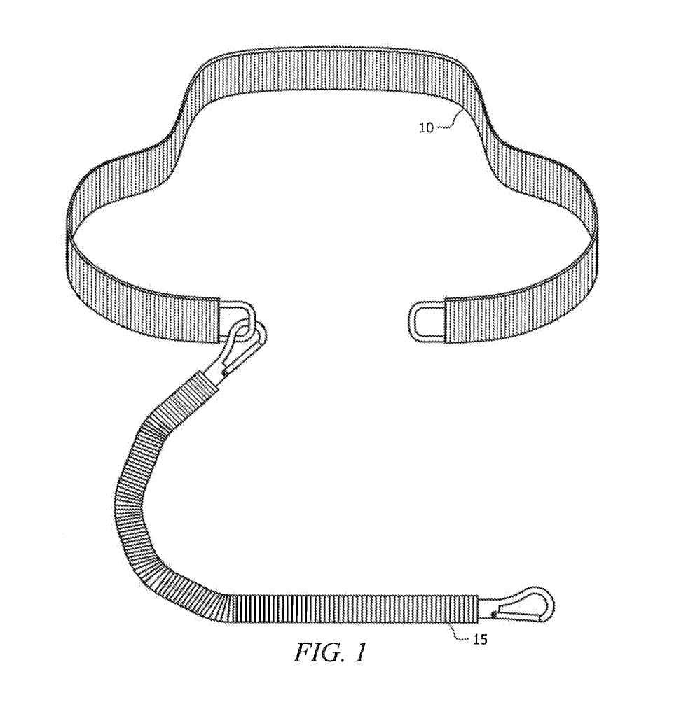

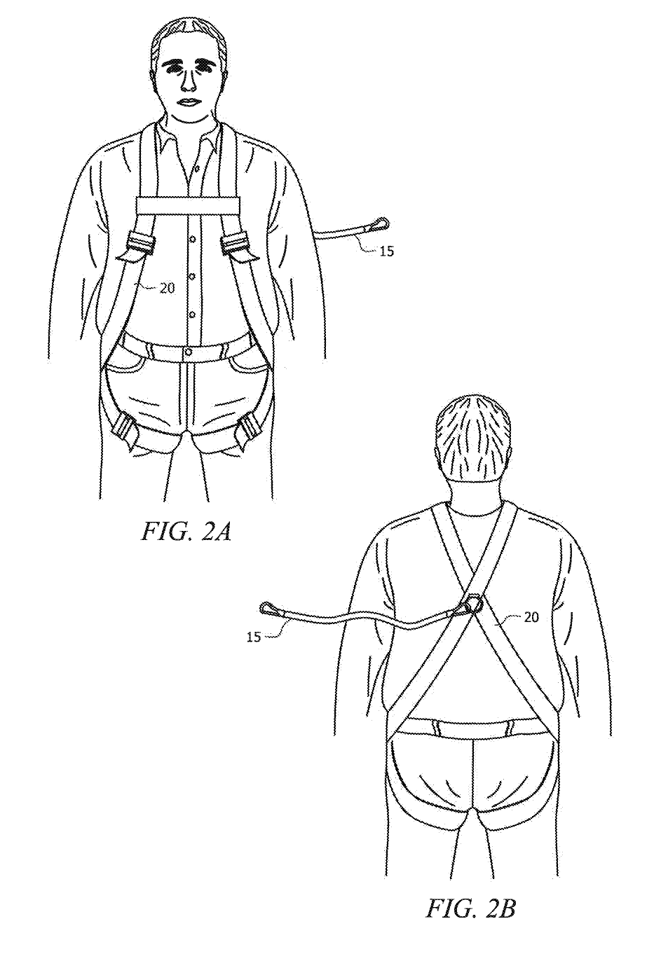

Turning now to the specific embodiments shown in the figures, FIG. 1 shows an exemplary embodiment of a safety belt 10 and a lanyard 15 that is removably attached, and FIGS. 2A and 2B show an exemplary embodiment of a safety harness 20 with a lanyard 15 that is removably attached. By way of non-exclusive example, end of service life indicators may be used in conjunction with any sort of fall arresting personal safety devices, with FIGS. 1 and 2A-2B providing illustrative uses. In the embodiment of FIG. 1, the safety belt 10 comprises webbing of sufficient strength/tenacity to reliably catch and support a user falling from a height. The lanyard 15 could also comprise such webbing. In FIG. 1, either the belt 10 or the lanyard 15 or both could include one or more end of service life indicators. In the embodiment of FIGS. 2A-2B, the safety harness 20 comprises webbing of sufficient strength/tenacity to reliably catch and support a user falling from a height. The lanyard 15 could also comprise such webbing. In FIGS. 2A and 213, either the harness 10 or the lanyard 15 or both could include one or more end of service life indicators.

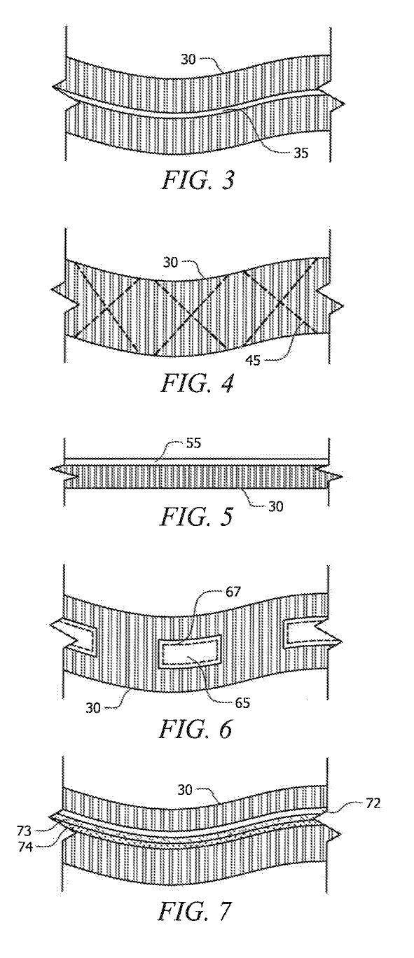

The one or more end of service life indicators used on the webbing of the embodiments of FIGS. 1, 2A, and/or 2B could be incorporated into the device using one or more techniques. FIGS. 3-8 provide some illustrative embodiments of such end of service life indicators. In the embodiment of FIG. 3, the end of service life indicator comprises a strip 35 of sensing material sensitive to exposure to one or more detrimental environmental conditions. The strip indicator of FIG. 3 is attached to the outside face of the webbing 30 of FIG. 3. The webbing 30 may be standard fall protection webbing, made of nylon, polyester, NOMEX™, or KEVLAR™ by way of nonexclusive example. Typically, such webbing is comprised of sufficient layers of material and/or has sufficient stitching support so that it meets the minimum strength/tenacity requirements of the local law and/or any higher industry or customer standard. The indicator strip 35 shown in the embodiment of FIG. 3 is sewn onto the outside surface of the webbing 30 near its approximate center. It should be understood, however, that one or more strip 35 may be located at various locations on the webbing 30. For example, a strip 35 may be located on either the upper or lower edge of the webbing 30. Alternatively, a strip 35 could be located on the upper and lower edge of the webbing, and might also be located near the center of the webbing. A strip 35 could be located on the inner surface of the webbing. And rather than being sewn onto the webbing, the indicator strip(s) could be attached by other means, such as adhesive for example. Rather than having a separate strip of sensing material for the indicator strip 35 that is sewn or otherwise attached to the webbing 30, embodiments could instead have thread of sensing material sewn directly into the webbing 30 itself to form the indicator strip 35. And in some embodiments, more than one strip 35 could be attached to the webbing 30 to provide multiple end of service life indicators, each perhaps sensing/detecting exposure to a different detrimental/degrading condition. FIG. 7 illustrates such an exemplary embodiment, in which the webbing 30 has a first indicator strip 72 for sensing/detecting a first degrading condition, a second indicator strip 73 for sensing/detecting a second degrading condition, and a third indicator strip 74 for sensing/detecting a third degrading condition.

FIG. 4 shows another exemplary embodiment. In the embodiment of FIG. 4, the end of service life indicator is formed by sewing thread of sensing material 45 into a pattern on the webbing 30. The thread might pass all the way through the thickness of the webbing 30 (so that the pattern is formed on both sides of the webbing), or it might be imprinted or attached on only one side. Alternative methods of forming a pattern of sensing material on a surface of the webbing 30 could also be used in other embodiments.

In FIG. 5, a sheet of sensing material 55 may be attached to a surface (typically the outside surface) of the webbing 30. This type of end of service life indicator is similar to the indicator strip(s) of FIG. 3, but uses a larger sheet of material. In FIG. 5, the indicator sheet 55 covers the entire outside surface of the webbing 30. The indicator sheet 55 might be attached to the webbing 30 via sewing. Alternatively, one or more other techniques could be used alone or in combination to attach the indicator sheet 55 to the webbing 30. For example, an adhesive could be used to attach the indicator sheet 55 to the webbing 30.

In FIG. 6, one or more patches 65 or badges of sensing material could be attached to the webbing 30. The location and number of such indicator patches 65 might vary depending on the specific conditions and environments in which the device might be used. And while the indicator patches 65 of the embodiment of FIG. 6 are sewn on (typically using standard thread stitching 67, perhaps with structural thread material), other means of attachment are also contemplated as will be understood by persons skilled in the art field.

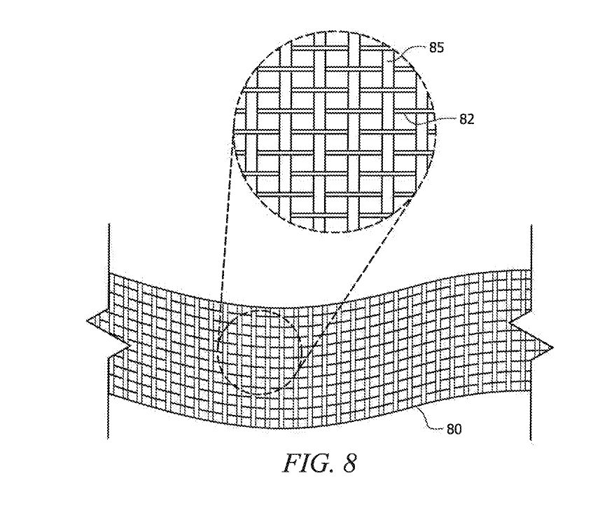

FIG. 8 shows a different sort of end of service life indicator. The webbing 80 of the embodiment of FIG. 8 has one or more types of tracer fibers 85 woven into the structural material of the webbing 80 itself. In other words, the webbing 80 is comprised of standard structural fibers 82 used to give the webbing its required strength/tenacity and of tracer fibers 85 of material that is sensitive to one or more degrading conditions (for sensing and denoting exposure to degrading conditions that might weaken the webbing, making it unsafe). So in the embodiment of FIG. 8, for example, the woven webbing 80 is formed by interweaving standard structural fiber threads 82 with tracer fiber threads 85. The webbing material might then be layered and/or stitched to add strength, forming the final webbing 80 from which fall arresting personal safety devices might be made. If this technique is employed, it is important that the tracer fibers do not weaken the strength/tenacity of the webbing to an unsafe level. Thus, in embodiments tracer fibers might need to be of sufficient strength, or they might need to be limited to a small percentage of overall fibers in the webbing. In embodiment, additional amounts of structural support fibers, additional layers of material, or additional strength stitching might be used to provide the necessary strength for the webbing (if for example, the tracer fibers tend to weaken the webbing's strength).

An exemplary method of forming a fall arresting personal safety device will now be described. First, webbing may be formed (or purchased so it may be provided for use in making the fall arresting personal safety device). The webbing might be woven, for example. In some embodiments, multiple layers of webbing material might be formed and/or joined together. And in some embodiments, stitching may be used to join layers and/or to add strength. A strip of sensing material might then be formed (or purchased so that it may be provided for use in making the device). The indicator strip material may be attached, either permanently or removably, to the webbing. The attachment might, by way of nonexclusive example, be by sewing. The webbing might be formed into a safety device (such as a belt, a harness, or a lanyard, by way of nonexclusive example). In some embodiments, the indicator strip might be added to the webbing before the webbing is formed into a safety device incorporated into a safety device), while in other embodiments, the one or more indicator strips might be attached to the webbing after the webbing is formed/incorporated into a safety device. Rather than indicator strips being attached to the webbing, in some embodiments indicator sheets or patches (or any other type of indicator) might be used. In other embodiments, indicator thread might be used, with the indicator thread being sewn into the webbing in a pattern. And in other embodiments, the webbing itself would actually be formed by weaving standard structural thread(s) with one or more indicator threads, such that the end of service life indicator(s) might be incorporated directly into the webbing that is used/incorporated into the safety device.

In use, an exemplary safety device with indicators might be worn in typical fashion by a user working at height (to secure the user safely to a support structure for example). The user might view the one or more indicators (as part of an inspection of the safety device for example) before and/or after each use. If the user discerns a change in visual appearance by the indicator(s), the user might then discard/retire the safety device. The user might then select and use a new/replacement safety device with indicators.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as comprises, includes, and having should be understood to provide support for narrower terms such as consisting of, consisting essentially of, and comprised substantially of. Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

What is claimed is:

1. A fall arresting personal safety device comprising:
webbing of sufficient strength to effectively catch and hold a user falling from a height; and
one or more end of service life indicators operable to indicate exposure to one or more degrading conditions;
wherein the one or more end of service life indicators change in visual appearance when exposed to sufficient concentration and duration of degrading condition to weaken the strength of the webbing;
wherein the webbing comprises one of the following: nylon, polyester, Nomex, Kevlar, and combinations thereof; and
wherein the webbing is formed into a safety harness, belt, or lanyard.

2. The device of claim 1 wherein the one or more end of service life indicators indicate exposure to one or more of the following degrading conditions: UV, heat, solvent, inorganic chemical, inorganic acid, organic acid, alkali, organic chemical, fertilizer, and/or bleaches.

3. The device of claim 1 wherein the change in visual appearance comprises a change in color.

4. The device of claim 1 wherein the webbing comprises an inner and an outer surface, and wherein the one or more end of service life indicators each comprise sensing material permanently attached to the outer surface of the webbing.

5. The device of claim 1 wherein the one or more end of service life indicators comprise sensing thread sewn into a pattern on the webbing.

6. The device of claim 1 wherein the one or more end of service life indicators comprise tracer fibers, and wherein the tracer fibers are woven into the webbing.

7. A fall protection safety device comprising:
webbing of sufficient strength to effectively catch and hold a user's fall from a height; and
one or more end of service life indicators operable to indicate exposure to one or more degrading condition.

8. The device of claim 7 wherein the one or more end of service life indicators indicate exposure to one or more of the following degrading conditions: UV, heat, solvent, inorganic chemical, inorganic acid, organic acid, alkali, organic chemical, fertilizer, and/or bleaches.

9. The device of claim 7 wherein the one or more end of service life indicators change in visual appearance when exposed to sufficient concentration and duration of degrading condition to weaken the strength of the webbing.

10. The device of claim 9 wherein the change in visual appearance comprises a change in color.

11. The device of claim 9 wherein the webbing comprises an inner and an outer surface, and wherein the one or more end of service life indicators each comprise sensing material permanently attached to the outer surface of the webbing.

12. The device of claim 9 wherein the one or more end of service life indicators comprise sensing thread sewn into a pattern on the webbing.

13. The device of claim 9 wherein the one or more end of service life indicators comprise tracer fibers, and wherein the tracer fibers are woven into the webbing.

14. The device of claim 9 wherein the webbing comprises one of the following: nylon, polyester, Nomex, Kevlar, and combinations thereof; and wherein the webbing comprises sufficient layers of material and stitching patterns so that the webbing meets strength requirements.

15. The device of claim 9 wherein the webbing is formed into a safety harness, belt, or lanyard.

16. A method of forming a fall protection safety device comprising:
providing webbing of sufficient strength to effectively catch and hold a user's weight;
providing one or more end of service life indicators;
permanently attaching the one or more end of service life indictors to the webbing; and
forming the webbing into the fall protection safety device.

17. The method of claim 16 further comprising forming the webbing.

18. The method of claim 16 wherein the webbing comprises an outside surface, and wherein the one or more end of service life indicators are sewn onto the outside surface of the webbing.

19. The method of claim 16 wherein the one or more end of service life indicators comprise sensing thread, and wherein the sensing thread is stitched onto the webbing.

20. The method of claim 16 wherein the one or more end of service life indicators comprise tracer fibers, and wherein permanently attaching the one or more end of service life indicators to the webbing further comprises weaving the tracer fibers into the webbing during formation.
